(19) United States
(12) Patent Application Publication
(10) Pub. No.: US 2026/0128655 A1
(43) Pub. Date: May 7, 2026

(54) STEPPER MOTOR AND WINDING DEVICE

(71) Applicant: AAC Microtech (Changzhou) Co., Ltd., Changzhou City (CN)

(72) Inventors: Feng Yan, Changzhou (CN); Junxiang Han, Changzhou (CN); Junsheng Wang, Changzhou (CN)

(21) Appl. No.: 19/036,050

(22) Filed: Jan. 24, 2025

Related U.S. Application Data
(63) Continuation of application No. PCT/CN2024/130485, filed on Nov. 7, 2024.

(51) Int. Cl. H02K 37/14; H02K 1/14; H02K 1/18; H02K 15/095

(52) U.S. Cl. CPC H02K 37/14; H02K 1/145; H02K 1/185; H02K 15/095

(57) ABSTRACT

The present disclosure provides a stepper motor and a winding device. The stepper motor includes: two plates arranged opposite to each other; a rotary shaft having two ends supported on the two plates, respectively; a magnet sleeved and fixed on an outer periphery of the rotary shaft; and a stator unit sleeved on the rotary shaft. The the stator unit includes windings arranged to space from the magnet. Each winding includes a respective casing that is hollow and arranged between the two plates, a respective claw pole fixed at an end of the respective casing and coaxial with the respective casing, and a respective coil wound on an outer periphery of the respective claw pole, and two ends of the respective coil extend outside the respective casing, respectively. The respective casing and portions of the respective claw pole in contact with the respective coil are coated with insulating coatings.

### CROSS REFERENCE TO RELATED APPLICATIONS

The present application is a continuation of PCT Patent Application No. PCT/CN2024/130485, filed Nov. 7, 2024, which is incorporated by reference herein in its entirety.

### TECHNICAL FIELD

The present disclosure relates to the field of motor technology, and in particular to a stepper motor and a winding device.

### BACKGROUND

The stepper motors have been widely used in fields such as electric motors and generators due to their high working efficiency and energy-saving advantages.

A stepper motor mainly includes a rotary shaft, magnets fixed to the outer periphery of the rotary shaft, and windings sleeved on the rotary shaft. A winding mainly includes a casing sleeved on the rotary shaft and being in rotational connection with the rotary shaft, a claw pole fixed to and coaxial with the casing, an insulation frame fixed to the outer periphery of the claw pole, and a coil fixed to the outer periphery of the frame.

In the related technologies, due to the insulation frame arranged between the claw pole and the coil of the stepper motor, the effective arrangement space of the stepper motor is reduced, and the torque of the stepper motor will be reduced on condition of unchanged volume.

Therefore, it is necessary to provide a new stepper motor and a winding device to address the above-mentioned technical problem.

### SUMMARY

The present disclosure aims to provide a new stepper motor and a winding device, in order to address the problem in related technologies that the effective arrangement space of the stepper motor is reduced, and the torque of the stepper motor is reduced on condition of unchanged volume.

To this end, in a first aspect, the present disclosure provides a stepper motor including: two plates arranged opposite to each other; a rotary shaft having two ends supported on and in rotational connection with the two plates, respectively; a magnet sleeved and fixed on an outer periphery of the rotary shaft; and a stator unit sleeved on the rotary shaft. The two plates are arranged on both sides of the magnet in an axial direction of the rotary shaft and arranged to space from the magnet, and the stator unit includes windings arranged to space from the magnet and fixed between the two plates. Each winding of the windings includes a respective casing that is hollow and arranged between the two plates, a respective claw pole fixed at an end of the respective casing and coaxial with the respective casing, and a respective coil wound on an outer periphery of the respective claw pole, and two ends of the respective coil extend outside the respective casing, respectively. The respective casing and portions of the respective claw pole in contact with the respective coil are coated with insulating coatings.

As an improvement, the respective claw pole includes a fixing portion fixed at the end of the respective casing and having an annular shape and a plurality of extension portions extending from an inner periphery of the fixing portion and along an axial direction of the respective claw pole, the plurality of extension portions are arranged at intervals, and the respective coil is wound and fixed on outer peripheries of the plurality of extension portions.

As an improvement, the respective casing includes a hollow cylinder, a first fixing portion having an annular shape and extending inward from an end of the cylinder away from the respective claw pole, and a plurality of first extension portions extending from an inner periphery of the first fixing portion and along an axial direction of the respective casing, and the plurality of first extension portions are arranged at intervals. Each first extension portion of the plurality of first extension portions extends between two respective adjacent extension portions of the plurality of extension portions of the respective claw pole, and the respective claw pole is fixed at an end of the cylinder.

As an improvement, the respective claw pole further includes an engagement portion extending outward from an outer periphery of the fixing portion and to outside of the respective casing. Each winding of the windings further includes a respective sheet-form frame, the respective sheet-form frame includes a platform portion stacked and fixed on a side of the fixing portion facing the plurality of extension portions, a protruding portion extending from an outer periphery of the platform portion and stacked and fixed on the engagement portion, and two winding columns extending from a side of the protruding portion away from the platform portion, the two winding columns space from each other, and the two ends of the respective coil are wound on the two winding columns, respectively.

As an improvement, a recessed wiring groove is defined on a surface of the protruding portion away from the fixing portion, and the wiring groove extends from the inner periphery of the fixing portion to one winding column of the two winding columns.

As an improvement, the respective sheet-form frame further includes a limit portion formed by extending a portion of the protruding portion facing the engagement portion, and the engagement portion is receivable in the limit portion, allowing the limiting portion is located in a same plane as the fixing portion.

As an improvement, an insulating coating coated on the respective claw pole covers the plurality of extension portions.

As an improvement, the stepper motor includes a plurality of windings arranged in sequence along the axial direction of the rotary shaft, wherein two respective fixing portions of every two adjacent windings of the plurality of windings abut against each other and are fixed to each other by welding.

In a second aspect, the present disclosure provides a winding device applicable to the stepper motor as illustrated above. The winding device includes a hollow sleeve and a mandrel inserted in the sleeve. The mandrel includes a first section, a second section, and a third section, the third section has an outer diameter larger than an outer diameter of the second section, and the first section has an outer diameter smaller than the outer diameter of the second section. The first section is configured for the respective claw pole to sleeve on the first section, the second section has extension grooves formed by depressions defined on an outer surface of the second section and fitted with the plurality of extension portions of the respective claw pole, and the third section is configured for the sleeve to sleeve on the third section. The respective claw pole is configured to sleeve on the first section by engaging each extension portion of the plurality of extension portions into a respective extension groove of the extension grooves.

Compared with the related technologies, in the stepper motor according to the present disclosure, the respective casing and portions of the respective claw pole in contact with the respective coil are coated with insulating coatings. In this way, the respective coil can be directly fixed to the respective claw pole, thereby freeing up the space occupied by the insulation frame and increasing the effective arrangement space of the stepper motor. When the increased space is used for coils, the total number of turns of the coils can be increased with the volume unchanged, thereby increasing the torque of the stepper motor. When the increased space is used for the magnet, the outer diameter of the magnet can be increased and the magnetic performance of the magnet can be improved, with the volume unchanged, thereby increasing the torque of the stepper motor. In other words, the effective arrangement space of the stepper motor according to the present disclosure can be increased, and the torque of the stepper motor also can be increased on condition of unchanged volume.

### BRIEF DESCRIPTION OF DRAWINGS

In order to illustrate the technical solutions in the embodiments of the present disclosure more clearly, the drawings to be used in the illustration of the embodiments will be briefly described below. It is obvious that the drawings mentioned in the following illustration are only some embodiments of the present disclosure. For those of ordinary skill in the art, other drawings may be obtained in accordance with these drawings without any inventive effort.

FIG. 1 is a schematic diagram of a three-dimensional structure of the stepper motor according to some embodiments of the present disclosure.

FIG. 2 is an exploded view of a portion of the structure of the stepper motor according to some embodiments of the present disclosure.

FIG. 3 is a cross-sectional view taken along the A-A line in FIG. 1.

FIG. 4 is an exploded view of the structures of the casing and the sheet-form frame of the stepper motor according to some embodiments of the present disclosure.

FIG. 5 is a schematic diagram of a structure of the winding device on which wires have been wound according to some embodiments of the present disclosure.

FIG. 6 is an exploded view of the structures shown in FIG. 5.

In the drawings:

100—stepper motor; 1—plate; 11—bearing; 2—rotary shaft; 3—magnet; 4—winding; 41 —casing; 411—cylinder; 412—first fixing portion; 413—first extension portion; 42—claw pole; 421—fixing portion; 422—extension portion; 423—engagement portion; 424—abutting portion; 43—coil; 44—sheet—form frame; 441—platform portion; 442—protruding portion; 4421—wiring groove; 443—winding column; 444—limit portion; 5. gasket; and 200—winding device; 201—sleeve; 202—mandrel; 2021—first section; 2022—second section; 20221—extension groove; 2023—third section.

### DETAILED DESCRIPTION OF EMBODIMENTS

The technical solutions in the embodiments of the present disclosure will be clearly and completely illustrated in conjunction with the accompanying drawings. Obviously, the illustrated embodiments are only a part of the embodiments of the present disclosure, not all of them. All other embodiments obtained by those skilled in the art based on the embodiments of the present disclosure without creative works fall within the scope of protection of the present disclosure.

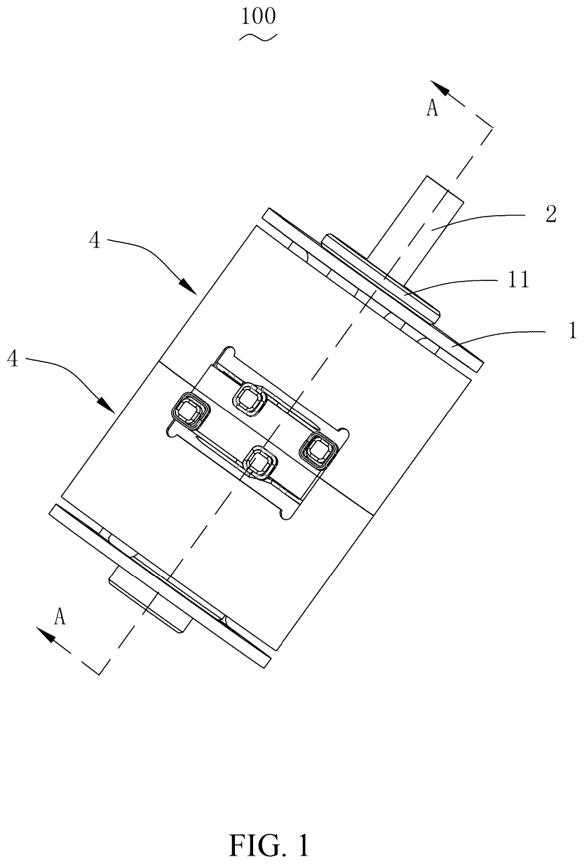

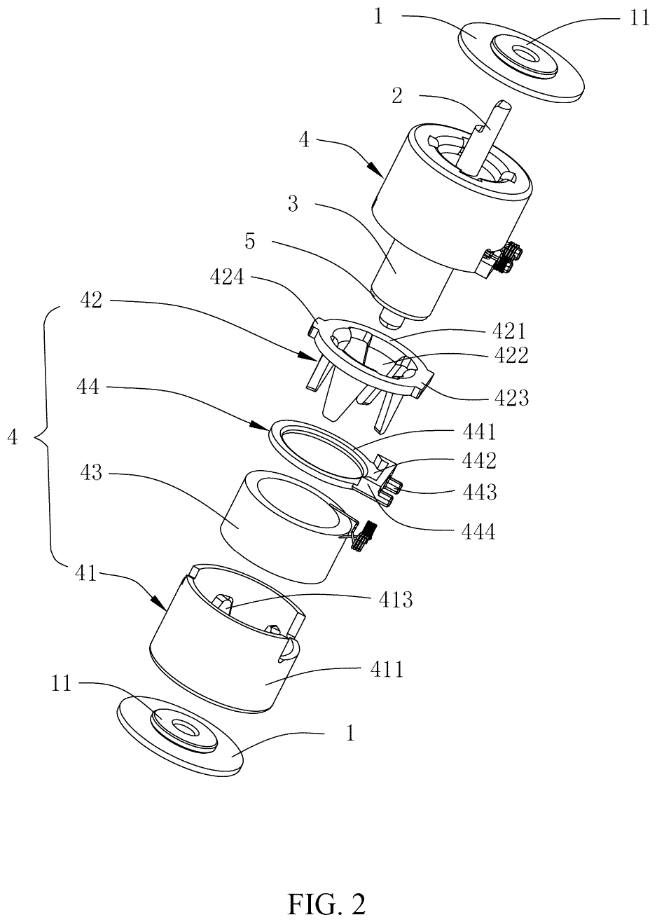

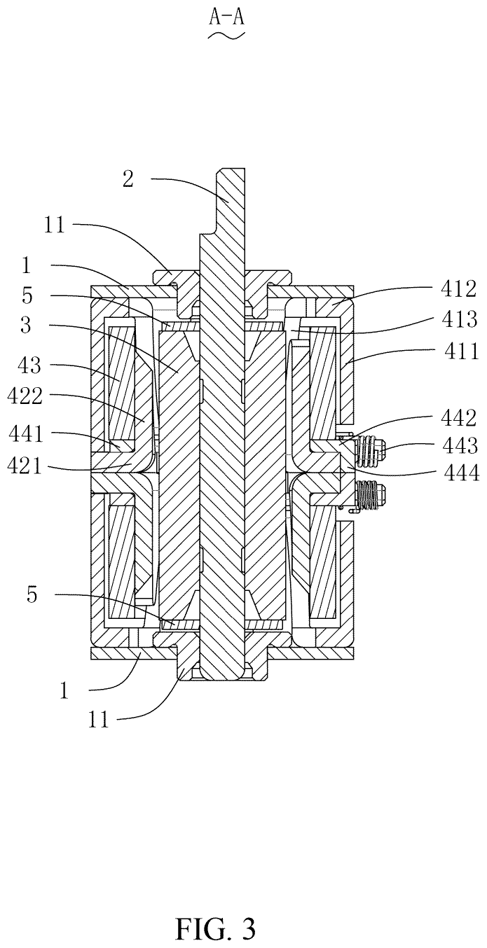

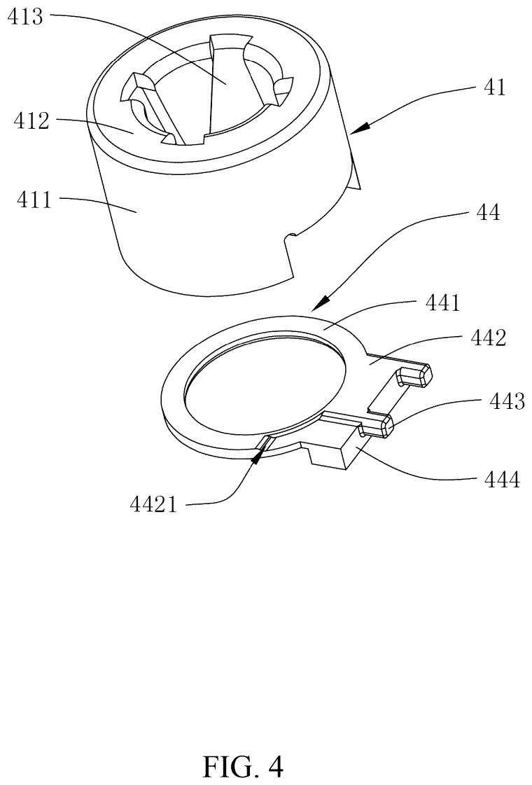

Some embodiments of the present disclosure provide a stepper motor 100, referring to FIGS. 1 to 4, the stepper motor includes: two plates 1 arranged opposite to each other; a rotary shaft having two ends supported on and in rotational connection with the two plates 1, respectively; a magnet 3 sleeved and fixed on an outer periphery of the rotary shaft; and a stator unit sleeved on the rotary shaft. The two plates 1 are arranged on both sides of the magnet 3 in an axial direction of the rotary shaft and arranged to space from the magnet 3, and the stator unit includes windings 4 arranged to space from the magnet 3 and fixed between the two plates 1.

In some embodiments, a respective bearing 11 is embedded and fixed in each plate 1, and each plate 1 is sleeved on and fixed to the rotary shaft via the respective bearing 11 and is in rotational connection with the rotary shaft.

The stepper motor includes a plurality of windings 4 arranged along the axial direction of the rotary shaft and having a same structure. In some embodiments, two windings 4 are provided.

Each winding 4 includes a respective casing 41 that is hollow and arranged between the two plates 1, a respective claw pole 42 fixed at an end of the respective casing 41 and coaxial with the casing 41, and a respective coil 43 wound on an outer periphery of the respective claw pole 42, and two ends of the respective coil 43 extend outside the respective casing 41, respectively. The respective casing 41 and portions of the respective claw pole 42 in contact with the respective coil 43 are coated with insulating coatings.

In some embodiments, the respective claw pole 42 includes a fixing portion 421 fixed at the end of the respective casing 41 and having an annular shape, a plurality of extension portions 422 extending from an inner periphery of the fixing portion 421 and along an axial direction of the respective claw pole, and an engagement portion 423 extending outward from an outer periphery of the fixing portion 421 and to outside of the respective casing 41. The plurality of extension portions 422 are arranged at intervals, and the respective coil 43 is wound and fixed on outer peripheries of the plurality of extension portions 422.

In some embodiments, an insulating coating coated on the respective claw pole 42 covers the plurality of extension portions 422.

In some embodiments, the respective claw pole 42 further includes an abutting portion 424 extending outward from the outer periphery of the fixing portion 421. The abutting portion 424 and the engagement portion 423 are located on both sides of the fixing portion 421. In this way, the abutting portion 424 can better limit the respective claw pole 42 to constrain the rotational freedom of the respective claw pole.

The respective coil 43 may be directly wound on the outer peripheries of the plurality of extension portions 422. Alternatively, wires may be prefabricated into the respective coil 43 fitted with the plurality of extension portions 422 first, and then the respective coil is sleeved and fixed on the outer peripheries of the plurality of extension portions 422.

In some embodiments, two fixing portions 421 of the two windings 4 abut against each other and are fixed to each other by welding. In this way, fixing strength between claw poles 42 can be improved.

The respective casing 41 includes a hollow cylinder 411, a first fixing portion 412 having an annular shape and extending inward from an end of the cylinder 411 away from the respective claw pole 42, and a plurality of first extension portions 413 extending from an inner periphery of the first fixing portion 412 and along an axial direction of the respective casing, and the plurality of first extension portions 413 are arranged at intervals. Each first extension portion 413 extends between two respective adjacent extension portions 422 of the respective claw pole 42, and the fixing portion 421 of the respective claw pole 42 is fixed at an end of the cylinder 411.

In some embodiments, each winding 4 further includes a respective sheet-form frame 44. The respective sheet-form frame 44 includes a platform portion 441 stacked and fixed on a side of the fixing portion 421 facing the plurality of extension portions 422, a protruding portion 442 extending from an outer periphery of the platform portion 441 and stacked and fixed on the engagement portion 423, and two winding columns 443 extending from a side of the protruding portion 442 away from the platform portion 441. The two winding columns 443 space from each other. The two ends of the respective coil 43 are wound on the two winding columns 443, respectively. In this way, the fixation of the two ends of the respective coil 43 can be facilitated.

In some embodiments, a recessed wiring groove 4421 is defined on a surface of the protruding portion 442 away from the fixing portion 421, and the wiring groove 4421 extends from the inner periphery of the fixing portion 421 to one winding column of the two winding columns 443. This design can make way for one of the ends of the respective coil 43.

In some embodiments, the respective sheet-form frame 44 further includes a limit portion 444 formed by extending a portion of the protruding portion 442 facing the engagement portion 423, and the engagement portion 423 is receivable in the limit portion 444, allowing the limiting portion 444 is located in a same plane as the fixing portion 421. In this way, assembly positioning can be achieved by the fitting of the engagement portion 423 in the limit portion 444, and degree of freedom of rotation of the respective claw pole 42 can be constrained.

In some embodiments, the stepper motor 100 further includes two gaskets 5 that are sleeved on the rotary shaft and space from each other. The two gaskets 5 are arranged to abut against two ends of the magnet 3, respectively.

Compared with the related technologies, in the stepper motor 100 according to the present disclosure, the respective casing 41 and portions of the respective claw pole 42 in contact with the respective coil 43 are coated with insulating coatings. In this way, the respective coil 43 can be directly fixed to the respective claw pole 42, thereby freeing up the space occupied by the insulation frame and increasing the effective arrangement space of the stepper motor 100. When the increased space is used for coils 43, the total number of turns of the coils 43 can be increased with the volume unchanged, thereby increasing the torque of the stepper motor 100. When the increased space is used for the magnet 3, the outer diameter of the magnet 3 can be increased and the magnetic performance of the magnet can be improved, with the volume unchanged, thereby increasing the torque of the stepper motor 100. In other words, the effective arrangement space of the stepper motor 100 according to the present disclosure can be increased, and the torque of the stepper motor also can be increased on condition of unchanged volume.

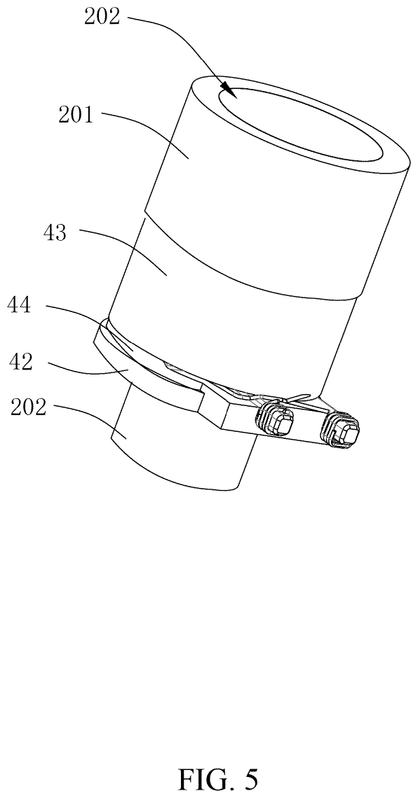

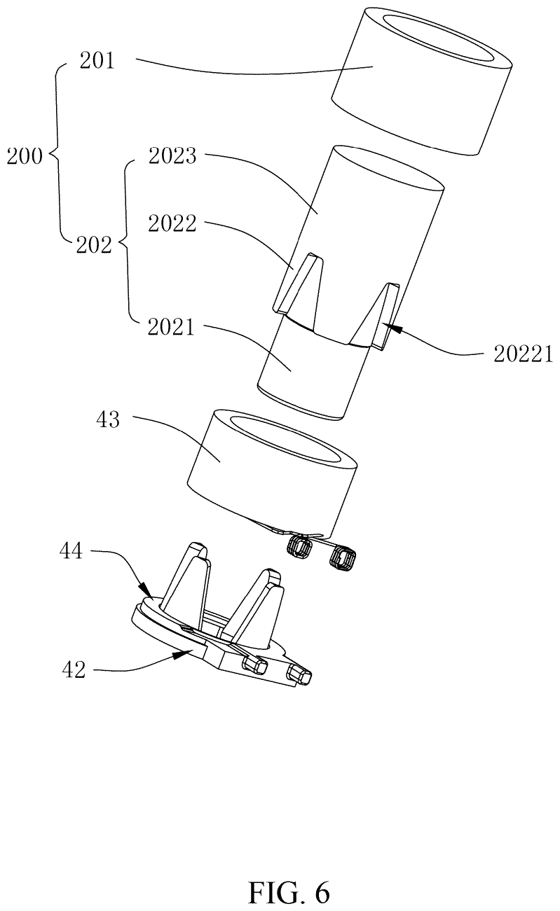

Some embodiments of the present disclosure provide a winding device 200 applicable to the stepper motor 100 as illustrated above. Referring to FIGS. 5 and 6, the winding device includes a hollow sleeve 201 and a mandrel 202 inserted in the sleeve 201. The mandrel 202 includes a first section 2021, a second section 2022, and a third section 2023, the third section 2023 has an outer diameter larger than an outer diameter of the second section 2022, and the first section 2021 has an outer diameter smaller than the outer diameter of the second section 2022. The first section 2021 is configured for the respective claw pole 42 to sleeve on the first section, the second section 2022 has extension grooves 20221 that are formed by depressions defined on an outer surface of the second section and fit with the plurality of extension portions 422 of the respective claw pole 42, and the third section 2023 is configured for the sleeve 201 to sleeve on the third section. The respective claw pole 42 is configured to sleeve on the first section 2021 by engaging each extension portion of the plurality of extension portions 422 into a respective extension groove of the extension grooves 20221.

The winding device 200 is mainly configured to wind the respective coil 43 as illustrate above on the plurality of extension portions 422 of the respective claw pole 42. In use, the fixing portion 421 of the respective claw pole 42 is sleeved on the mandrel 202, and the plurality of extension portions 422 are arranged to get close to the sleeve 201. Then, one end of the respective coil 43 is wound on a winding column 443, and the respective coil 43 is sequentially wound on the outer peripheries of the plurality of extension portions 422. After winding the respective coil 43, the other end of the respective coil 43 is wound on the other winding column 443, then the mandrel 202 is extracted from the fixing portion 421 of the respective claw pole 42, at the same time, the sleeve 201 is press against the respective coil 43 to prevent the respective coil 43 from being pulled out. After extracting the mandrel 202 from the sleeve 201, the sleeve 201 is removed, then winding of the respective coil 43 is finished.

The number of the extension grooves 20221 is the same as the number of the plurality of extension portions 422 and their structures are matched. In this way, collapse or bending of the respective coil 43 can be prevented when winding the respective coil 43. Depending on actual needs, the plurality of extension portions 422 may be fitted in the extension grooves 20221 to form at least partially closed structures or fully closed structures.

With the winding device 200 as illustrate above, the respective coil 43 can be stably and quickly wound on the plurality of extension portions 422 of the respective claw pole 42, and unstable and slow winding of the respective coil 43 can be prevented.

The above are only embodiments of the present disclosure. It should be pointed out that those skilled in the art can make improvements without departing from the inventive concept of the present disclosure, and these improvements all fall within the scope of protection of the present disclosure.

What is claimed is:

1. A stepper motor, comprising:
two plates arranged opposite to each other;
a rotary shaft having two ends supported on and in rotational connection with the two plates, respectively;
a magnet sleeved and fixed on an outer periphery of the rotary shaft; and
a stator unit sleeved on the rotary shaft;
wherein the two plates are arranged on both sides of the magnet in an axial direction of the rotary shaft and arranged to space from the magnet, and the stator unit comprises windings arranged to space from the magnet and fixed between the two plates;
wherein each winding of the windings comprises a respective casing that is hollow and arranged between the two plates, a respective claw pole fixed at an end of the respective casing and coaxial with the respective casing, and a respective coil wound on an outer periphery of the respective claw pole, and two ends of the respective coil extend outside the respective casing, respectively; and
wherein the respective casing and portions of the respective claw pole in contact with the respective coil are coated with insulating coatings.

2. The stepper motor according to claim 1, wherein the respective claw pole comprises a fixing portion fixed at the end of the respective casing and having an annular shape and a plurality of extension portions extending from an inner periphery of the fixing portion and along an axial direction of the respective claw pole, the plurality of extension portions are arranged at intervals, and the respective coil is wound and fixed on outer peripheries of the plurality of extension portions.

3. The stepper motor according to claim 2, wherein the respective casing comprises a hollow cylinder, a first fixing portion having an annular shape and extending inward from an end of the cylinder away from the respective claw pole, and a plurality of first extension portions extending from an inner periphery of the first fixing portion and along an axial direction of the respective casing, and the plurality of first extension portions are arranged at intervals; and
wherein each first extension portion of the plurality of first extension portions extends between two respective adjacent extension portions of the plurality of extension portions of the respective claw pole, and the respective claw pole is fixed at an end of the cylinder.

4. The stepper motor according to claim 2, wherein the respective claw pole further comprises an engagement portion extending outward from an outer periphery of the fixing portion and to outside of the respective casing;
wherein each winding of the windings further comprises a respective sheet-form frame, the respective sheet-form frame comprises a platform portion stacked and fixed on a side of the fixing portion facing the plurality of extension portions, a protruding portion extending from an outer periphery of the platform portion and stacked and fixed on the engagement portion, and two winding columns extending from a side of the protruding portion away from the platform portion, the two winding columns space from each other, and the two ends of the respective coil are wound on the two winding columns, respectively.

5. The stepper motor according to claim 4, wherein a recessed wiring groove is defined on a surface of the protruding portion away from the fixing portion, and the wiring groove extends from the inner periphery of the fixing portion to one winding column of the two winding columns.

6. The stepper motor according to claim 4, wherein the respective sheet-form frame further comprises a limit portion formed by extending a portion of the protruding portion facing the engagement portion, and the engagement portion is receivable in the limit portion, allowing the limiting portion is located in a same plane as the fixing portion.

7. The stepper motor according to claim 2, wherein an insulating coating coated on the respective claw pole covers the plurality of extension portions.

8. The stepper motor according to claim 2, comprising a plurality of windings arranged in sequence along the axial direction of the rotary shaft, wherein two respective fixing portions of every two adjacent windings of the plurality of windings abut against each other and are fixed to each other by welding.

9. A winding device, applicable to the stepper motor according to claim 2, wherein the winding device comprises a hollow sleeve and a mandrel inserted in the sleeve;
wherein the mandrel comprises a first section, a second section, and a third section, the third section has an outer diameter larger than an outer diameter of the second section, and the first section has an outer diameter smaller than the outer diameter of the second section;
wherein the first section is configured for the respective claw pole to sleeve on the first section, the second section has extension grooves that are formed by depressions defined on an outer surface of the second section and fit with the plurality of extension portions of the respective claw pole, and the third section is configured for the sleeve to sleeve on the third section; and
wherein the respective claw pole is configured to sleeve on the first section by engaging each extension portion of the plurality of extension portions into a respective extension groove of the extension grooves.
